(19) United States
(12) Patent Application Publication
(10) Pub. No.: US 2016/0130015 A1
(43) Pub. Date: May 12, 2016

(54) UNIVERSAL MOUNTING PANEL FOR A ROTARY-WING DRONE

(71) Applicant: PARROT, Paris (FR)

(72) Inventors: Christine Caubel, Paris (FR); Flavien Morra, Paris (FR)

(21) Appl. No.: 14/678,761

(22) Filed: Apr. 3, 2015

(30) Foreign Application Priority Data
Apr. 24, 2014 (FR) 1453712

(51) Int. Cl. B64D 47/00; B64D 47/08; B64C 27/08; B64C 27/00; B64C 39/02

(52) U.S. Cl. CPC B64D 47/00; B64C 27/001; B64C 39/024; B64C 27/08; B64D 47/08; B64C 2201/127; B64C 2201/024; B64C 2201/027

(57) ABSTRACT

The drone body (10) comprises a frame (12), integral with arms (14) for connection to propulsion units (16), an electronic board (24) carrying components as well as accelerometer, inertial and altimeter sensors, a support for this board, and an elastic interface (26) between the frame and the board support, to filter and absorb the mechanical vibrations. The board support is a panel (22) made of an electrically conductive metal material. The panel carries on a back side thermally conductive areas at places located opposite heat-sink electronic components mounted on the board on the back side. The panel is moreover electrically connected to a ground potential of the electronic board, so as to form an electromagnetic shielding screen. It is further mechanically connected to the frame with uncoupling by the elastic interface (26) interposed between the panel and the frame.

The invention relates to the rotary-wing drones, such as quadricopters.

Such drones comprise a drone body and a plurality of propulsion units, each having a propeller driven by a respective motor. Each propulsion unit is mounted at the end of a respective arm for connection to the drone body. A typical example of such a drone is the AR.Drone 2.0 of Parrot SA, Paris.

The drone body comprises therein a frame integral with the arms for connection to the propulsion units, as well as an electronic board carrying various components and sensors, in particular an inertial unit allowing to determine at any time the exact attitude of the drone and the position thereof in space, to control in a differentiated manner the different motors so as to follow the evolutions wanted by a user or controlled by an automatic pilot.

This electronic board is mounted on a support that is connected to the frame of the drone by an elastic interface comprising a material for filtering and absorbing the mechanical vibrations caused by the motors and the propellers, so that these vibrations do not disturb the operation of the sensors and in particular of the inertial unit.

The WO 2001/058255 A1 (Parrot) describes more precisely such an electronic board support structure, where the elastic interface is in the form of a foam ring added on a corresponding shoulder of the drone frame. The navigation electronic board is hung from the fixation part through connection feet, with no direct mechanical contact with a vibrating part of the drone. It is hence possible to eliminate, thanks to the absorbing mechanical interface, the interfering vibrations generated by the propulsion units, so avoiding that these latter disturb the operation of the navigation sensors, and without the need to use a low-pass filtering of the signal collected by these sensors.

Recently, the improvements added to these drones have led to an increase of complexity of the circuits, and also of the sensitivity thereof to the different external interferences, whether they are mechanical interferences (vibrations, sudden drone attitude changes, etc.) or electrical interferences (interferences induced by the surrounding electromagnetic fields, in particular those produced by the rotating motors).

These interfering phenomena may affect not only the operation of the electronic circuits, but also the image taken by the camera on-board the drone, because the vibrations produce low-amplitude and high-frequency oscillations of the drone and, consequently, the axis of the camera. After scanning of the camera's sensor, these oscillations translate into a so-called wobble effect in the image obtained, where the straight lines seem to be broken and form zigzags. Even if the amplitude of this deformation is not very high, it is very visible and degrades the final quality of the image, especially when the latter is picked up in high resolution, typically in HD resolution (1920×1080 pixels).

Finally, according to another aspect, the use of digital components executing more and more complex operations at a high clock rate leads to a significant warming of these components, liable to cause thermal drifts that will have to be detected and compensated for.

Finally, the evident constraints of light weight, peculiar to any aircraft, impose to limit the mechanical structures and pieces of equipment to the strict minimum as regards the mass thereof, without thereby altering the stiffness and robustness thereof.

Other support structures are described in the US 2012/0083945 A1 and WO 2013/053475 A2, but they do not allow to solve the problems exposed hereinabove.

The object of the invention is to solve all the difficulties mentioned hereinabove, by proposing a new internal structure of a drone body.

More precisely, the invention applies to a rotary-wing drone such that disclosed in the above-mentioned WO 2011/058255 A1, i.e. a drone comprising, in a manner known per se, a drone body and a plurality of propulsion units mounted at the end of respective connection arms. The drone body comprises: a frame, integral with the arms for connection to the propulsion units; an electronic board, carrying electronic components as well as accelerometer, inertial and altimeter sensors; a support for the electronic board; and an elastic interface between the frame and the board support, comprising a material adapted to filter and absorb mechanical vibrations coming from the propulsion units.

Characteristically of the invention, the drone body comprises a panel made of an electrically conductive metal material, this panel forming said electronic board support, the electronic board being fixed to a back of this panel. The panel carries on a back side thermally conductive areas at places located opposite at least one heat-sink electronic component mounted on the electronic board on the back side, and it is electrically connected to a ground potential of the electronic board, so as to form an electromagnetic shielding screen for this electronic board. The panel is mechanically connected to the frame with uncoupling by said elastic interface interposed between the panel and the frame.

According to various advantageous subsidiary characteristics:
the electrically conductive metal material of the panel comprises magnesium and alloys thereof;
the elastic interface comprises a plurality of support spacers interposed between the panel and the frame, each spacer comprising a stud made of elastomeric material with a first end connected to the panel and a second, opposite, end connected to the frame;
the panel is a continuous single-piece panel, except for orifices for the passage of connection wires and/or sensor signals of the electronic board;
the panel further comprises longitudinal edges forming a lateral shielding with respect to electronic components mounted on the back side of the electronic board;
the panel comprises on the back side an access cavity to connectors for connection to an auxiliary electronic circuit, in particular a circuit comprising at least one radiofrequency antenna component;
the drone further comprises a video camera, mechanically integral with the electronic board;
the at least one heat-sink electronic component mounted on the back side of the electronic board is one of: a microcontroller, a memory component, a video camera;
the drone body supports a drone power-supply rechargeable removable battery, and the panel further comprises at least one loop for the passage of a fixation strap of this removable battery.

An exemplary embodiment of the invention will now be described, with reference to the appending drawings in which the same references denote identical or functionally similar elements throughout the figures.

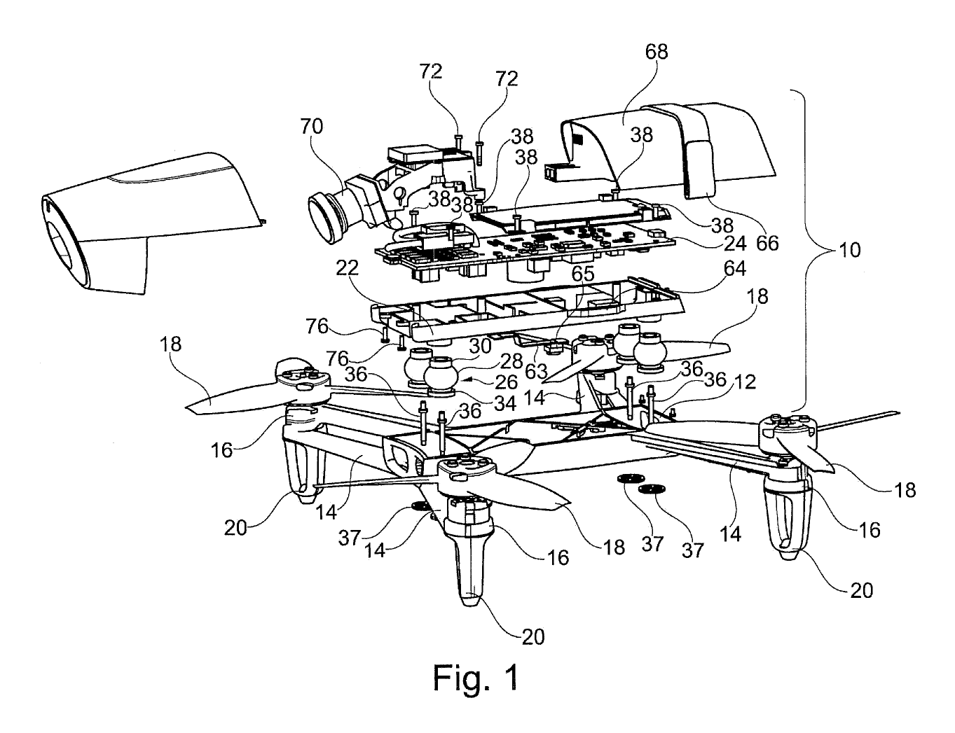

FIG. 1 is a perspective exploded view of a drone according to the invention showing the different internal elements of the drone body, dissociated from each other.

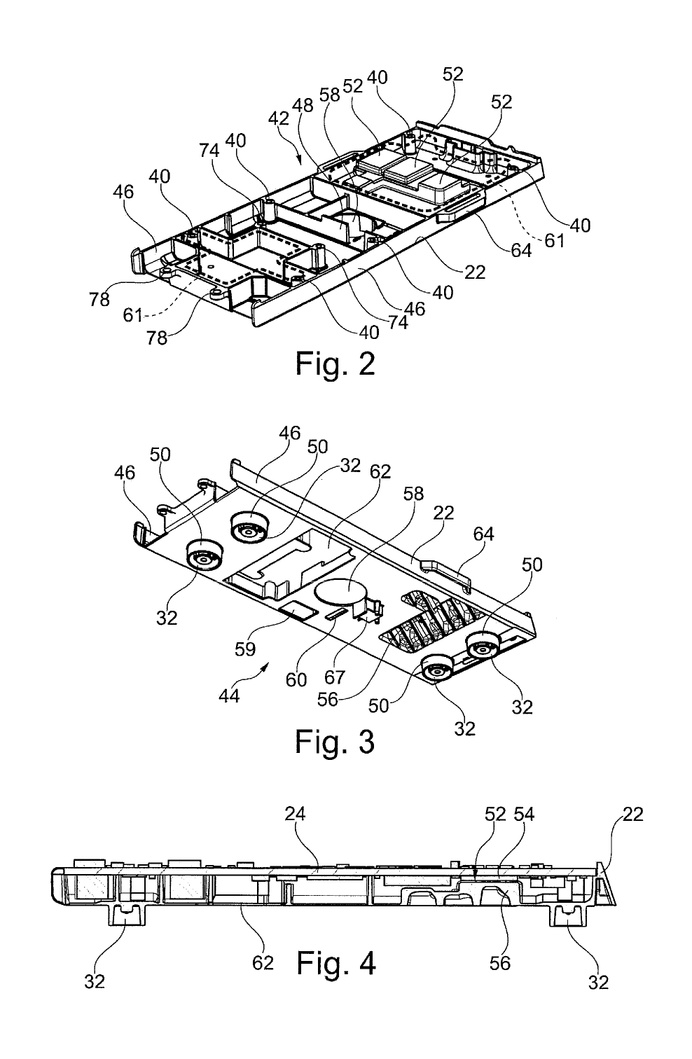

FIG. 2 is a perspective top view of the specific metal panel implemented by the invention.

FIG. 3 shows this same panel, in a perspective bottom view.

FIG. 4 is a longitudinal sectional view of the panel of FIGS. 2 and 3, with the electronic board and its components mounted thereon.

In FIG. 1, a quadricopter-type drone has been shown, with a drone body 10 comprising in the lower portion a frame 12 integral with four single-piece connection arms 14 radiating from the frame. Each arm is equipped at its distal end with a propulsion unit 16 comprising a motor driving into rotation a propeller 18 extending in an approximately horizontal plane above the arm 14. In the lower portion, the propulsion unit 16 is continued by a footing stirrup 20 by which the drone can rest on the ground when stopped.

The drone body comprises a support 22 intended to receive the main electronic board 24 of the drone. This support 22 is in the form of a panel, which will be described in more detail hereinafter with reference to FIGS. 2 to 4.

The panel 22 is not fastened to the frame, but it is connected to the latter through an elastic interface consisted of a plurality of support spacers 26 interposed between the frame 12 and the panel 22. Each spacer 26 comprises a strut 28 made of elastomeric material, with an upper end 30 connected by a non-rigid link to the panel 22, for example by extension of a shoulder in the upper portion of the elastomeric strut into a corresponding recess 32 (FIGS. 3 and 4) formed in the lower portion of the panel 22. At its opposite, lower, end, the strut 28 is provided with a shoulder 34 that is inserted into the frame 12. The connection between the frame 12 and the strut 28 is for example made through a pin 36, screwed at its upper portion to the panel, at the centre of the block 50, passing freely through the strut and including, in its lower portion, a screw rod passing through the frame and to which will be screwed, under this frame, a wide internally threaded part 37 comparable to a bolt. This rod/wide screw system must not in any case be connected to the frame 12, otherwise vibrations could be transmitted to the panel, and it has further a pull-out prevention function for the elastomeric material interfaces 26.

The configuration of the support panel 22 will now be described in more details. This panel receives, as mentioned hereinabove, the electronic board 24, which is fastened to the panel 22 by means of screws such as 38 (FIG. 1) received in internally threaded housings 40 (FIG. 2) opening at the upper portion of the panel.

In FIGS. 2 and 3 are illustrated the upper 42 and lower 44 faces of the panel 22, respectively.

This panel 22 is a single-piece element made of a light-weight metal material, for example magnesium or a magnesium alloy chosen for its light weight and its mechanical robustness. It is in the form of a plate provided with two longitudinal side edges 46 and various internal ribs such as 48.

Characteristically, the metal plate forming the panel 22 includes in its upper portion planar surfaces such as 52 (FIG. 2) adapted to come into contact with components such as 54 (FIG. 4) mounted on the lower face of the electronic board 24. These surfaces 52 will serve as heat-transmission elements, to evacuate the excess calories generated by the components in contact with these surfaces, towards cooling fins such as 56 formed in the lower portion of the panel 22 (FIGS. 3 and 4), opposite the contact surfaces 52 formed at the upper portion. An excessive warming of the components the more liable to heat, such as microcontroller, memory components or even video camera as the case may be, will then be avoided.

The plate forming the panel 22 is made as an uninterrupted continuous single-piece element, except for small-size openings such as 58, 59 or 60. The window 58 serves as a window for an ultrasound altimeter sensor mounted on the lower face of the electronic board 24, and the window 59 serves as a window for the transformer of this same sensor, mounted on the lower face of the electronic board, to save thickness. The window 60 allows the passage of a flat cable 63 (FIG. 1) for the connection to a vertical-sight camera 65, located under the panel 22 and whose body rests on the podium 67 (FIG. 3) formed on the lower face of the panel 22.

The plate forming the panel 22, once connected to the mass of the electronic circuit of the board 24, will serve as an electromagnetic shielding screen for this electronic board, with respect to the surrounding interfering radiations, in particular those generated by the motors of the propulsion units 16, from which will be protected, thanks to the presence of the longitudinal side edges 46, the most sensitive components mounted on the lower face of the electronic board 24. The areas in which these sensitive components are implanted on the electronic board (in the front of the drone for the power part and in the rear for the logical part) with respect to the panel 22 are schematized in 61. None of the lateral, front or rear walls in these areas has any opening.

On its lower face, the panel 22 is provided with a wide window such as 62, to allow the passage of cables for the connection of the electronic board 24 to the motors of the propulsion units 16, as well as cables for the connection to an auxiliary electronic board, in particular a board carrying one or several Wi-Fi antenna components, which will not be affected by the electromagnetic shielding effect. In short, this wide window 62 will be positioned above connectors placed on the lower face of the electronic board 24 so as to be able to connect different components that do not need the shielding of the panel (vertical camera, coaxial cables towards antenna boards, connectors towards other auxiliary boards, motor cables . . . ).

Finally, the plate 22 may be provided, on one of its lateral faces 46, with a loop or an eyelet hole 64 intended to receive a strap 66 (FIG. 1) for closing a drone power-supply rechargeable removable battery 68.

As regards the block carrying the camera 70 on-board the drone (FIG. 1), the latter is fastened to the panel 22, for example by means of screws 72 introduced in threaded holes 74 of the panel (FIG. 2), and screws 76 introduced into orifices 78. That way, the camera 70 is mechanically uncoupled from the frame 12, thanks to the intermediate elastic spacers 26, which allows to suppress almost all the vibrations generated by the motors, and hence the above-mentioned wobble effect.

It should also be noted that the just-described support serves, with respect to the electronic board 24 and to all the elements fastened to the platen 22, as a shock damper at the landing of the drone, avoiding in particular to wear out and to damage the components, connectors, etc., arranged on the electronic board 24, as well as the camera 70.

1. A rotary-wing drone, comprising a drone body (10) and a plurality of propulsion units (16) mounted at the end of respective connection arms (14), the drone body (10) comprising:
a frame (12), integral with arms for connection to the propulsion units;
an electronic board (24), carrying electronic components as well as accelerometer, inertial and altimeter sensors;
a support for the electronic board; and
an elastic interface (26) between the frame and the board support, comprising a material adapted to filter and absorb mechanical vibrations corning from the propulsion units,
characterized in that:
the drone body comprises a panel (22) made of an electrically conductive metal material, this panel forming said electronic board support, the electronic board (24) being fixed to a back side of this panel;
the panel carries on a back side thermally conductive areas (52) at places located opposite at least one heat-sink electronic component (54) mounted on the electronic board of the back side;
the panel is electrically connected to a ground potential of the electronic board, so as to form an electromagnetic shielding screen for this electronic board; and
the panel is mechanically connected to the frame with uncoupling by said elastic interface (26) interposed between the panel and the frame.

2. The drone of claim 1, wherein the electrically conductive metal material of the panel comprises magnesium and alloys thereof.

3. The drone of claim 1, wherein the elastic interface comprises a plurality of support spacers (26) interposed between the panel and the frame, each spacer comprising a stud (28) made of elastomeric material with a first end (30) connected to the panel and a second, opposite, end (34) connected to the frame.

4. The drone of claim 1, wherein the panel (22) is a continuous single-piece panel, except for orifices (58, 59, 60) for the passage of connection wires and/or sensor signals of the electronic board.

5. The drone of claim 4, wherein the panel (22) further comprises longitudinal edges (22) forming a lateral shielding with respect to electronic components mounted on the back side of the electronic board.

6. The drone of claim 1, wherein the panel comprises on the back side an access cavity (62) to connectors for connection to an auxiliary electronic circuit.

7. The drone of claim 6, wherein the auxiliary electronic circuit comprises at least one radiofrequency antenna component.

8. The drone of claim 1, further comprising a video camera (70), mechanically integral with the electronic board.

9. The drone of claim 1, wherein the at least one heat-sink electronic component (54) mounted on the back side of the electronic board is one of: a microcontroller, a memory component, a video camera.

10. The drone of claim 1, wherein the drone body supports a drone power-supply rechargeable removable battery (68), and the panel further comprises at least one loop (64) for the passage of a fixation strap (66) of this removable battery.
